(19) United States
(12) Patent Application Publication
(10) Pub. No.: US 2005/0278520 A1
(43) Pub. Date: Dec. 15, 2005

(54) Task scheduling apparatus in distributed processing system

(75) Inventors: Akira Hirai, Kawasaki (JP); Kouichi Kumon, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/954,205

(22) Filed: Oct. 1, 2004

Related U.S. Application Data
(63) Continuation of application No. PCT/JP02/03324, filed on Apr. 3, 2002.

(51) Int. Cl. G06F 9/00

(52) U.S. Cl. 713/1

(57) ABSTRACT

A task scheduling apparatus of a distributed processing system having a plurality of processing units for processing a plurality of distributed tasks is provided. As a first task scheduling method, the task scheduling apparatus allocates a task to a processing unit having the lowest temperature. As a second task scheduling method, the task scheduling apparatus selects a task based on both temperature of each processing unit and characteristic values of tasks related to degree of temperature rise or consumption power increase caused by execution, and allocates the selected task to the object processing unit. For example, as the second task scheduling method, a task producing a large degree of temperature rise (for example, a task having a number of instructions to be processed per unit time) is allocated to a processing unit having a low temperature. With such a scheduling method, uniform temperature of each processing unit can be obtained.

### FIELD OF THE INVENTION

The present invention relates to a task scheduling apparatus and a task scheduling method, and more particularly a task scheduling apparatus and a task scheduling method in a distributed processing system having a plurality of processing units for distributing and processing a plurality of tasks. The present invention also relates to a program for enabling a computer to execute the task scheduling.

### BACKGROUND OF THE INVENTION

In recent years, with remarkably improved performance of a processor such as CPU and MPU, processor consumption power is increasing. This increases generated heat quantity of the processor, and causes a problem of temperature rise of processor.

In order to prevent such temperature rise of the processor, measures against heat have been taken to the processor. Such measures include mounting a fan onto the processor, and optimizing airflow inside the housing of the processor. However, an increased thermal design power (TDP) resulting from improved processor performance has caused a larger fan size and a larger volume of the housing. As a result, a problem of increased cost of the overall equipment has been produced, as well as increased equipment size.

Another measure having been employed is to provide a mechanism for controlling voltage and frequency of the processor. With this mechanism, the voltage and/or the frequency of the processor are reduced for heat reduction in case necessary. However, this measure is not recommendable because processing capacity of the processor is inevitably deteriorated.

Meanwhile, a distributed processing system or a parallel processing system has been put into use. By providing a plurality of processing units each having a processor or a computer including a processor, tasks are distributed to and processed in the plurality of processing units. Thus, load distribution or function distribution of the processing is performed to increase processing speed.

In such a system, since the plurality of processing units operate, measures against heat becomes more important. At the same time, a particular problem arises because of the provision of the plurality of processing units. Namely, there is a case that the temperature rise in a particular processor, or a particular processor group, becomes larger than in other processors. Such a processor (or a processor group) varies with the processing situations from time to time and accordingly the processor of large temperature rise is not fixed. As a result, it becomes necessary to attach fans onto all processors as mentioned above, which brings about a large cost increase. Also, when the method of the voltage or frequency reduction is adopted, it becomes meaningless to provide a multiprocessor configuration with a plurality of processors or a distributed computing environment to increase the processing speed.

### DISCLOSURE OF THE INVENTION

The present invention has been derived in consideration of the aforementioned situation, and it is an object of the present invention to provide a task scheduling apparatus and a task scheduling method to substantially equalize the temperature of each processing unit in a distributed processing system having a plurality of processing units.

In order to attain the aforementioned object, a task scheduling apparatus according to a first aspect of the present invention is a task scheduling apparatus provided in a distributed processing system having a plurality of processing units for distributing and processing a plurality of tasks and a measuring apparatus for measuring the temperature or the consumption power of each processing unit. The task scheduling apparatus for scheduling the tasks to be executed in each processing unit includes: a comparator comparing the temperature or the consumption power of each processing unit measured by the measuring apparatus; and a task allocator for allocating a task to a processing unit having the lowest temperature or the lowest consumption power measured by the measuring apparatus after the comparison by the comparator.

Also, a task scheduling method in accordance with the first aspect of the present invention is provided. The task scheduling method is executed either in at least one of the plurality of processing units or in a control unit provided separately from the plurality of processing units in a distributed processing system having a plurality of processing units for distributing and processing a plurality of tasks and a measuring apparatus for measuring the temperature or the consumption power of each processing unit. The task scheduling method includes: comparing the temperature or the consumption power of each processing unit measured by the measuring apparatus; and allocating a task to a processing unit having the lowest temperature or the lowest consumption power measured by the measuring apparatus after the comparison.

Further, a program in accordance with the first aspect of the present invention enables either at least one of the plurality of processing units for distributing and processing a plurality of tasks, or a computer of a control unit provided separately from the plurality of processing units, to execute the aforementioned task scheduling method according to the first aspect.

Still further, a distributed processing system in accordance with the first aspect is provided with a plurality of processing units for distributing and processing a plurality of tasks. The distributed processing system includes: a measuring apparatus measuring the temperature or the consumption power of each of the plurality of processing units; and a task scheduling apparatus either provided separately from the plurality of processing units or provided in at least one of the plurality of processing units. The task scheduling apparatus compares the temperature or the consumption power of each processing unit measured by the measuring apparatus, and allocates a task to a processing unit having the lowest temperature or the lowest consumption power measured by the measuring apparatus after the comparison.

The task scheduling apparatus may be provided either in at least one of the plurality of processing units, or separately from the plurality of processing units.

According to the first aspect of the present invention, because a task is allocated to a processing unit having the lowest temperature or the lowest consumption power, the processing unit having the lowest temperature or the lowest consumption power generates heat as the task is being processed, and thus the temperature of the processing unit of interest is increased. On the other hand, because a task is not allocated to other processing units having higher temperature or higher consumption power, the heat quantity is decreased in these processing units. As a result, it becomes possible to make the temperature of each processing unit equalized.

According to a second aspect of the present invention, a task scheduling apparatus for scheduling the tasks to be executed in each processing unit is provided in a distributed processing system having a plurality of processing units for distributing and processing a plurality of tasks and a measuring apparatus for measuring the temperature or the consumption power of each processing unit. The task scheduling apparatus includes: a memory storing characteristic values of the tasks related to the degree of temperature rise or consumption power increase in each processing unit caused by the execution of each task on a task-by-task basis; and a task allocator selecting a task to be allocated to an object processing unit from the tasks waiting for execution, based on both the temperature or the consumption power measured by the measuring apparatus and the task characteristic values stored in the memory with respect to the object processing unit for task allocation, and allocating the selected task to the object processing unit.

Also, a task scheduling method in accordance with the second aspect is provided in a distributed processing system having a plurality of processing units for distributing and processing a plurality of tasks and a measuring apparatus for measuring the temperature or the consumption power of each processing unit. The task scheduling method is executed either in at least one of the plurality of processing units or in a control unit provided separately from the plurality of processing units. The task scheduling method includes: selecting a task to be allocated to an object processing unit for task allocation from the tasks waiting for execution, based on both the temperature or the consumption power measured by the measuring apparatus and task characteristic values stored in either an internal memory or an external shared memory, being related to the degree of temperature rise or consumption power increase in each processing unit caused by the execution of each task with respect to the object processing unit; and allocating the selected task to the object processing unit.

Further, a program in accordance with the second aspect of the present invention enables either at least one of the plurality of processing units for distributing and processing a plurality of tasks, or a computer of a control unit provided separately from the plurality of processing units, to execute the aforementioned task scheduling method according to the second aspect.

Still further, a distributed processing system in accordance with the second aspect, having a plurality of processing units for distributing and processing a plurality of tasks, is provided. The distributed processing system includes: a measuring apparatus measuring the temperature or the consumption power of each of the plurality of the processing units; a memory storing characteristic values of the tasks related to the degree of temperature rise or consumption power increase in each processing unit caused by the execution of each task on a task-by-task basis; and a task allocator selecting a task to be allocated to an object processing unit from the tasks waiting for execution, based on both the temperature or the consumption power measured by the measuring apparatus and the task characteristic values stored in the memory with respect to the object processing unit, and allocating the selected task to the object processing unit.

The task scheduling apparatus may be provided either in at least one of the plurality of processing units, or separately from the plurality of processing units.

According to the second aspect of the present invention, a task is allocated based on both the temperature or the consumption power of each processing unit and the characteristic value of a task related to the degree of the temperature rise or the consumption power increase in each processing unit produced by the execution of each task. For example, a task having a characteristic value representing a small degree of the temperature rise or the consumption power increase is allocated to a processing unit having a high temperature or high consumption power. Or, to a processing unit having a low temperature or low consumption power, the task allocation is performed in an opposite manner. In such a way, it becomes possible to make the temperature of each processing unit equalized.

Further scopes and features of the present invention will become more apparent by the following description of the embodiments with the accompanied drawings.

### BRIEF DESCRIPTION OF THE DRAWINGS

FIG. 1 shows a block diagram illustrating an exemplary configuration of a distributed processing system according to a first embodiment of the present invention.

FIG. 2 shows data stored in a shared memory.

FIG. 3 shows a flowchart illustrating a processing flow of a second task scheduling method executed in each processor.

FIG. 4 shows a processing flow of a third task scheduling method executed in each processor.

FIG. 5 shows a block diagram illustrating an exemplary configuration of a distributed processing system according to a second embodiment of the present invention.

### DETAILED DESCRIPTION OF THE PREFERRED EMBODIMENTS

The preferred embodiment of the present invention is described hereinafter referring to the charts and drawings.

### First Embodiment

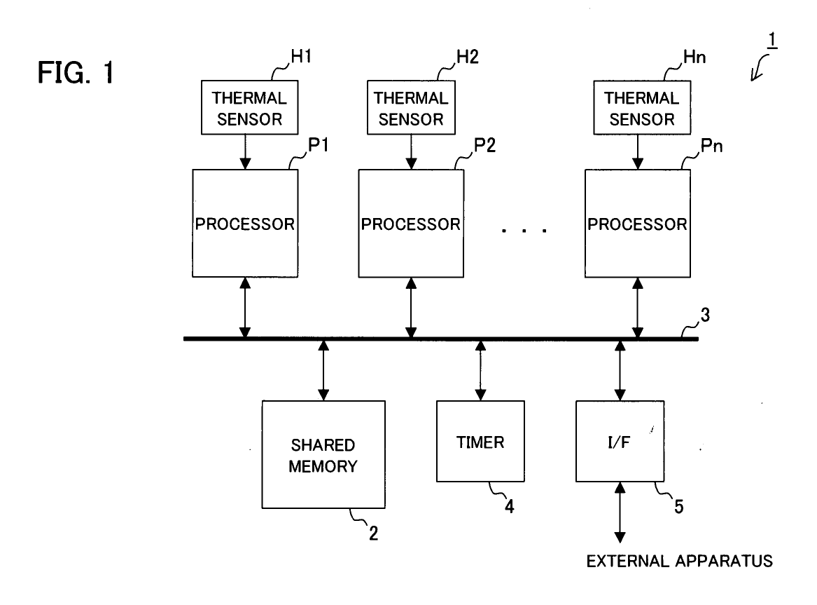

FIG. 1 shows a block diagram illustrating an exemplary configuration of a distributed processing system according to a first embodiment of the present invention. This distributed processing system 1 is, for example, a multiprocessor system in a single housing, and includes n processors P1-Pn (where n is an integer of 2 or more, the same being applicable hereafter), n thermal sensors H1-Hn, a shared memory 2, a bus 3, a timer 4, and a communication interface unit (I/F) 5.

Processors P1-Pn, shared memory 2, timer 4, and I/F 5 are connected to bus 3. Through bus 3, processors P1-Pn read out a program or a data stored in shared memory 2, or write a program or a data generated through processing into shared memory 2.

Each processor P1-Pn is exemplarily configured of CPU, MPU, or the like, or an apparatus (for example, a processor board) configured of CPU, MPU, or the like, with its peripheral hardware circuits. This processor has a memory (including a cache memory) inside, and executes the operating system (OS) and an application program (a task program corresponding to a task in a task queue waiting for execution) stored in shared memory 2.

Further, each processor P1-Pn is provided with a performance monitoring function. By use of this performance monitoring function, processor P1-Pn can measure numerical values representing the performance. Such numerical values include the number of instructions executed, the time or the number of clocks required for the execution of a task, the number of memory accesses, the number of instructions executed per unit time, the number of memory accesses per unit time, and combinations thereof (for example, a total value of the number of instructions executed per unit time and the number of memory accesses). It is possible to designate to each processor in advance the numerical values to be measured.

In timer 4, a time is set by any of processors P1-Pn. When the time having been set elapses, timer 4 outputs a timer interruption signal to bus 3. The output interruption signal is received and processed in any one of processors P1-Pn. This timer 4 is for use when, for example, putting a task into a sleep state for a predetermined duration of time, waking up the task having been in the sleep state so as to execute the task by the processor.

I/F 5 is connected to an external apparatus (computer, etc.) in this distributed processing system 1, and executes communication interface processing (such as protocol processing) between this external apparatus and the processor. On receipt of data from the external apparatus, this I/F 5 outputs an interruption signal to bus 3. The interruption signal is received and processed in any one of the processors.

The thermal sensors H1-Hn are the sensors for measuring each temperature of processors P1-Pn. Processor Pi (where i is any integer from 1 to n, the same being applicable hereafter) reads out the temperature of the corresponding thermal sensor Hi at predetermined certain time intervals, and stores the readout temperature into a predetermined area (which is to be described later) in the shared memory.

As shown in FIG. 1, the thermal sensors H1-Hn may be either provided separately from processors P1-Pn, or embedded in the hardware circuits of processors P1-Pn. When the thermal sensors H1-Hn are provided separately from processors P1-Pn, the thermal sensors are attached in contact with the surface of processors P1-Pn, or disposed at an interval (of a few millimeters) in the vicinities of processors P1-Pn. In addition, instead that each processor P1-Pn reads each temperature of the thermal sensors H1-Hn and stores it to shared memory 2, it is also possible that each thermal sensor H1-Hn is directly connected to bus 3 and stores the temperature measured at a certain time interval into shared memory 2.

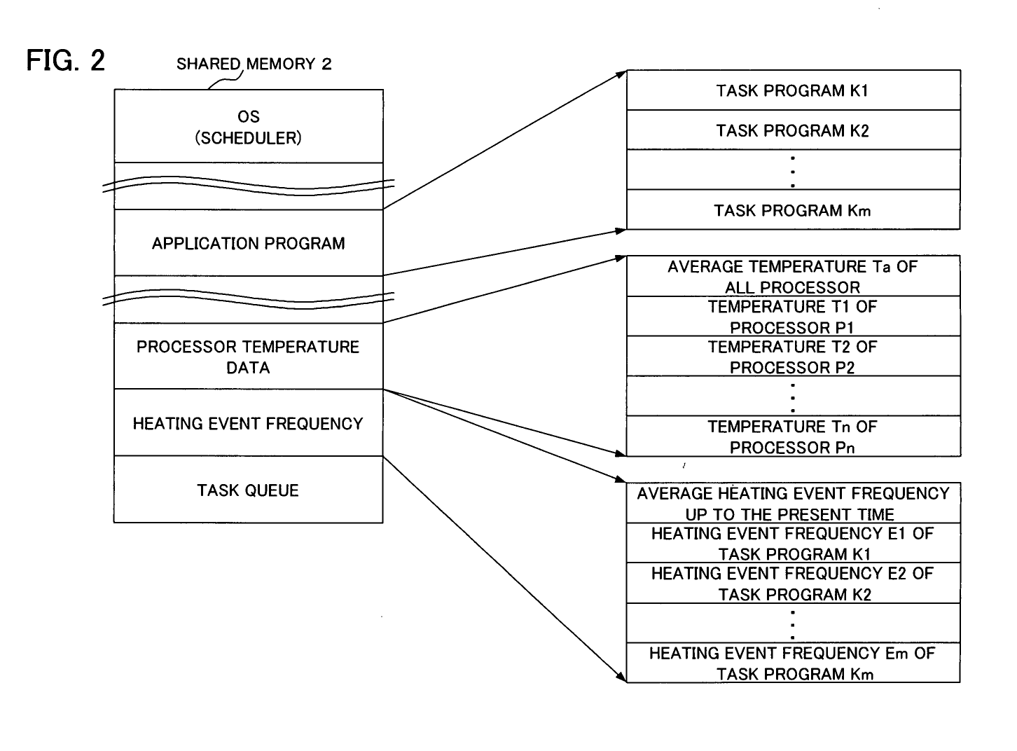

Shared memory 2 is constituted of, for example, RAM in which the operating system (OS) program, application programs, etc. are stored. FIG. 2 shows data (including programs) stored in shared memory 2. The data stored in shared memory 2 include application programs, temperature data of the processors, heating event frequency data, task queues, etc.

OS is a shared OS executed by processors P1-Pn. Processors P1-Pn execute this OS after reading out. A scheduler (scheduling program) is included in this OS. Processors P1-Pn execute scheduling processing according to this scheduling program. As described later, in this scheduling processing, task scheduling processing (that is, task selection and allocation processing) according to the first embodiment of the present invention is executed.

An application program is divided into each task (task program) that is an execution unit to be executed by each processor P1-Pn. In FIG. 2, one application program is divided into m task programs K1-Km (where m is an integer of 2 or more, the same being applicable hereafter). Both function distribution and load distribution, or either one of them, is realized by P1-Pn's execution of these task programs K1-Km, and thus high-speed processing of the application program is achieved.

In the task queue, tasks (for example, identifiers representing task programs) are waiting for execution. Each processor P1-Pn selects a task from the tasks having been placed in the task queue, and allocates the selected task to the processor of interest or another processor. The processor to which the task is allocated executes the task program corresponding to the allocated task. Also, when a new task is generated by executing the task program, each processor P1-Pn places this new task into the task queue.

The processor temperature data and the heating event frequency data are used as task selection criterion when each processor P1-Pn executes task scheduling processing, or as selection criterion of an object processor for task allocation.

The processor temperature data includes data items of the mean temperature Ta of the entire processors, and the temperatures T1-Tn of processors P1-Pn.

The temperatures T1-Tn are respectively measured by the thermal sensors H1-Hn, and stored by processors P1-Pn with certain time intervals. Therefore, the temperatures T1-Tn are updated with certain time intervals.

The mean temperature Ta is a mean value of the temperatures T1-Tn. Namely, Ta is obtained by Ta=(T1+T2+ . . . +Tn)/n. This mean temperature Ta is calculated and updated by processor Pi based on the temperatures T1-Tn, for example, after the temperature Ti is written by processor Pi. Accordingly, this mean temperature Ta is updated when each processor P1-Pn writes its own temperature.

Heating event frequency data are exemplary characteristic values of tasks related to the degrees of temperature rise or consumption power increase in each processor. The heating event frequency data include both a mean value Ea of the heating event frequencies (i.e. mean heating event frequency) up to the present time, and each heating event frequency E1-Em with respect to each task program K1-Km.

Here, a ‘heating event’ refers to an event that causes heat production in the processor, which may be exemplified by an instruction executed by the processor, an access to the processor internal memory or shared memory 2. Accordingly, the ‘heating event frequency’ is represented by the number of instructions executed per unit time in the processing of the task or the OS, the number of memory accesses per unit time, and combinations thereof (for example, a sum of the number of instructions and the number of memory accesses executed per unit time).

Additionally, in place of the heating event frequency, it is also possible to use ‘the number of heating events’ such as the number of instructions and the number of memory access included in each task. Also, it is possible to use time duration necessary for processing the task as task selection criterion.

According to this embodiment of the present invention, as an example, the ‘heating event frequency’ is used, and also the number of instructions executed per unit time in executing each task is used as the heating event frequency. Namely, when the number of instructions having been executed is defined as I1-Im for each task program K1-Km, and the time duration (or the number of clocks) necessary for executing these instructions is defined as t1-tm, then heating event frequencies E1-Em become E1=I1/t1, . . . , E1=Ii/ti, . . . , Em=Im/tm, respectively. When the number of clocks is used for the time duration, the unit in measuring the heating event frequency is the number of instructions per clock (IPC).

For example, when a task program Kj (where j is any integer from 1 to m, the same being applicable hereafter) is executed by processor Pi, processor Pi measures the number of instructions and the time required to the execution of the task program Kj, using the performance monitoring function. Processor Pi then calculates a heating event frequency Ej from the number of instructions and the time. Thereafter, processor Pi stores the heating event frequency Ej into shared memory 2.

It may be possible for processor Pi to obtain these values of the number of instructions and time by calculating the difference between each value read out from the performance monitoring function when starting the execution of the task program Kj and each value read out from the performance monitoring function when completing the execution of the task program Kj. Or, it may be possible to obtain in such a way that processor Pi resets the value of the performance monitoring function to zero when starting the execution of the task program Kj, and obtains from the value read out from the performance monitoring function when completing the execution of the task program Kj.

Further, there may be cases that, with respect to the same task program Kj, a heating event frequency value obtained at a certain time of execution is different from a heating event frequency obtained at a different time of execution. For example, assuming the task program Kj has a conditional branch or a repeated loop, the above-mentioned situation of the different heating event frequency values may occur when the branch selected or the repeated number of loops at a certain time of execution differs from the branch selected or the repeated number of loops at a different time of execution.

Therefore, the heating event frequency Ej can be defined as: (a) the value obtained when the task program Kj is executed most recently; or (b) the mean heating event frequency value of the entire cases of the task program Kj having been executed up to the present time.

In the former case (a), it is sufficient for processor Pi to write (overwrite) into a predetermined address of shared memory 2 a heating event frequency Ej obtained from the performance monitoring function after the execution of the task program Kj.

In the latter case (b), although omitted in FIG. 2, the total number of instructions (denoted as Ijₐₗₗ) having been executed up to the present moment by the task program Kj and the total time spent for the execution (denoted as tjₐₗₗ) are stored. For example, when the task program Kj has been executed x times up to the present moment, Ijₐₗₗ=Ij₁+Ij₂+ . . . +Ijₓ, tjₐₗₗ=tj₁+tj₂+ . . . +tjₓ (where Ijₖ is the number of instructions executed when the task program Kj is executed for the k-th time, in which k is any integer from 1 to x, and tjₖ is the execution time when the task program Kj is executed for the k-th time). The total number of instructions divided by the total time is determined as the heating event frequency Ej. That is, Ej=Ijₐₗₗ/tjₐₗₗ.

For example, after processor Pi executes the task program Kj for the x+1'th time, processor Pi adds the number of instructions Ijₓ₊₁ and the execution time tjₓ₊₁ to Ijₐₗₗ and tjₐₗₗ having been stored in shared memory 2, respectively. Based on the values after the addition, processor Pi calculates Ej=Ijₐₗₗ/tjₐₗₗ and then writes (overwrites) the calculated Ej to shared memory 2 as a new heating event Ej.

Additionally, since the heating event frequency cannot be obtained if no task is executed, predetermined values are used as the heating event frequency values E1-Em at the time point of no task program having been executed (that is, an initial value). These initial values may be obtained, for example, by executing task programs K1-Km through an experiment or a simulation.

‘Mean heating event frequency Ea up to the present moment’ is a mean heating event frequency value of the entire tasks having been executed so far by the entire processors P1-Pn.

Namely, the mean value Ea is derived from a sum of the total number of instructions having been executed for the respective task programs K1-Km (i.e. Iₐₗₗ=I1ₐₗₗ+I2ₐₗₗ+ . . . +Imₐₗₗ) divided by a sum of the total execution time of the tasks having been executed (i.e. tₐₗₗ=t1ₐₗₗ+t2ₐₗₗ+ . . . +tmₐₗₗ), that is, the mean value Ea=Iₐₗₗ/tₐₗₗ.

Assuming that the execution time of each task is constant, the mean value Ea may also be expressed by the following formula.
Ea={(E1₁+E1₂+ . . . +E1ₙ₁)+(E2₁+E2₂+ . . . +E2ₙ₂)+ . . . +(Ej₁+Ej₂+ . . . +Ejₙⱼ)+ . . . +(Em₁+Em₂+ . . . +Emₙₘ)}/(n1+n2+ . . . +nj+ . . . +nm).
(where the task Kj is executed for nj times, and each heating event frequency from the first time to the nj-th time is Ej₁-Ejₙⱼ)

After executing the task program Kj, processor Pi updates the heating event frequency Ej of the task program Kj, and also calculates the mean heating event frequency Ea. Thereafter, processor Pi updates the value in shared memory 2, using the calculated value.

In such a multiprocessor system 1, when the task (task program) processing having been executed is completed, or switchover of tasks occurs, or interruption from timer 4 or I/F 5 occurs, each processor P1-Pn selects one task from the tasks having been placed in the task queue, and executes task scheduling to allocate the selected task to the processor of interest or other processors. For this task scheduling, there are some methods shown in the following.

(1) The First Task Scheduling Method

The first task scheduling method is to allocate a task to the processor having the lowest temperature based on the temperatures of the processors in the idle state, i.e. in a state such that no task is being executed, when a plurality of processors being in the idle state are existent.

For example, when the interruption signal of the preset time lapse produced by timer 4 is received in processor Pi, processor Pi temporarily suspends the task having been executed so far, and executes the scheduler. Or, when processor Pi is in the idle state, processor Pi immediately starts to execute the scheduler on receipt of the interruption signal.

Processor Pi judges whether a plurality of processors in the idle state exist when receiving the interruption signal. If processor Pi of interest is in the idle state, the processor Pi is also included in the object processors. Whether a processor is in the idle state may be confirmed by inquiring each processor from processor Pi, or may be judged by reading out a predetermined area in shared memory 2 in case that each processor writes its own state (either idle state or task processing state) into this predetermined area.

Succeedingly, when a plurality of processors in the idle state are existent, processor Pi reads out temperatures of the processors in the idle state from shared memory 2, and selects the processor having the lowest temperature. When there are a plurality of processors having the lowest temperature, as one example, it may be possible to generate pseudo random numbers and select one processor based on the generated numbers.

Next, processor Pi allocates to the selected processor a task to shift to a wakeup state.

When the interruption signal is input from I/F 5 to processor Pi, in a similar manner to the above, processor Pi selects a processor having the lowest temperature from the processors in the idle state, and may allocate a task (for example, data reception processing from I/F 5) to the selected processor.

As such, among the processors in the idle state, a task is allocated to, and executed in, the processor having the lowest temperature. This enables equalization of the heat quantity of each processor, so that uniform processor temperature can be achieved.

Additionally, when one processor is existent in the idle state, it may be possible to allocate a task to this processor, or to allocate to the other processor having the lowest temperature. Even when no processor is existent in the idle state, it may be possible to allocate the task to a processor having the lowest temperature. If the task is allocated to a processor not in the idle state, and if the priority of the allocated task is higher than that of the task being in execution, it may be possible to suspend the task in execution and execute the newly allocated task.

(2) A Second Task Scheduling Method

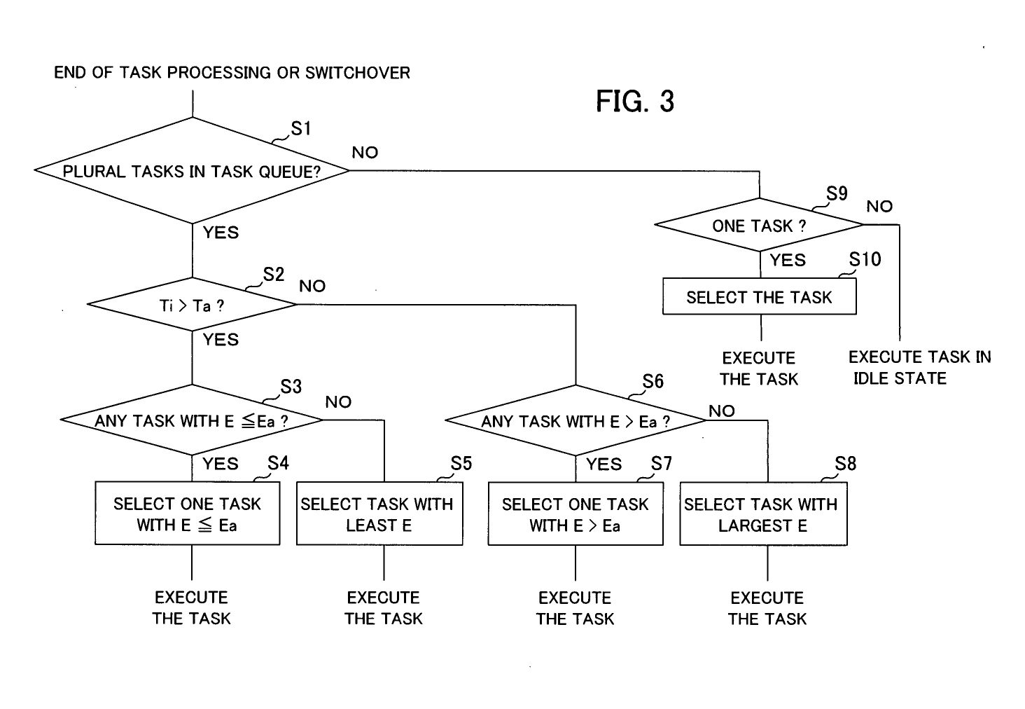

A second task scheduling method is to select and allocate a task based on both the processor temperature and the heating event frequency. FIG. 3 shows a flowchart illustrating a processing flow of the second task scheduling method executed in each processor. This processing is apart of the scheduler in the OS, as described earlier.

In processor Pi, when task processing having been executed so far is completed, or a task switchover is performed, processor Pi accesses shared memory 2, and judges whether a plurality of tasks are existent in the task queue of shared memory 2 (S1).

When a plurality of tasks are existent in the task queue (YES in S), processor Pi compares the temperature Ti of its own with the mean temperature Ta stored in shared memory 2 (S2). Here, as to the temperature Ti of the processor Pi, it is possible to use the temperature concerned stored in shared memory 2, or to use the temperature read out by processor Pi from the thermal sensor Hi at the time this comparison is executed.

If Ti>Ta (YES in S2), processor Pi reads out from shared memory 2 both the heating event frequency E of each task existent in the task queue and the mean heating event frequency Ea, and compares the heating event of each task with the mean heating event frequency Ea, respectively (S3) Then, processor Pi judges whether any task having the heating event frequency E not higher than the mean heating event frequency Ea (namely, E≦Ea) exists in the task queue (S3).

If there are task(s) satisfying E≦Ea existent in the task queue (YES in S2), processor Pi selects a task from the tasks satisfying E≦Ea (S4), and executes the selected task. When only one task satisfies E≦Ea, the task concerned is selected.

Here, when a plurality of tasks satisfying E≦Ea are existent, it may be possible to select a task having the lowest heating event frequency among those tasks, or to select a task having a heating event frequency of medium order. Or differently, by generating pseudo random numbers, at ask may be selected based on the generated random numbers. Also, it may also be possible to select a task having the highest priority based on the task priorities, in a similar way to the ordinary scheduling. Further, if a plurality of tasks having the identical priority are existent, a task placed in the highest position in the queue, or a task having been placed into the queue in earlier timing, may be selected.

Meanwhile, when there are no task satisfying E≦Ea in the task queue (NO in S3), processor Pi selects a task having the lowest heating event frequency E from the tasks existent in the task queue (S5), and executes the selected task.

In step S2, when Ti≦Ta (NO in S2), processor Pi judges whether a task(s) having a higher heating event frequency E (E>Ea) than the mean heating event frequency Ea is existent among the tasks existent in the task queue (S6).

If a task satisfying E>Ea is existent in the task queue (YES in S6), processor Pi selects a task from among the tasks satisfying E>Ea (S7), and executes the selected task. If only a single task satisfying E>Ea is existent, the task concerned is selected.

If a plurality of tasks satisfying E>Ea are existent, in a similar way to the aforementioned, it may be possible to select a task having the highest heating event frequency, the lowest heating event frequency, or a medium heating event frequency. Or differently, it may be possible to select a task either based on the numerical values of the pseudo random numbers, or through the same selection processing based on the priority as in the ordinary scheduling.

When no task satisfies E>Ea in the task queue (NO in S6), processor Pi selects a task having the highest heating event frequency E among the tasks in the task queue (S8) and executes the selected task.

In step S1, when a plurality of tasks are not existent in the task queue, processor Pi further judges whether the number of the task in the task queue is one or not (S9). If a single task is existent in the task queue (YES in S9) processor Pi selects and executes the task concerned (S10) If no task is existent in the task queue (NO in S9), processor Pi executes an idle task.

The selected task is deleted from the task queue. Further, when no task is in the task queue, processor Pi may enter into a suspension state, instead of executing the idle task. In such a case, at the time a new task is generated in the task queue, processor Pi is shifted from the suspension state to the operation state by another processor in the operation state.

As such, according to the second task scheduling method, the temperature Ti of processor Pi is compared with the mean temperature Ta. When the temperature Ti is no higher than the mean temperature Ta, a task having as high heating event frequency as possible is selected among the tasks in the task queue. Accordingly, in general, the heat quantity produced from processor Pi after executing the selected task is higher than the average heat quantity. On the other hand, when the temperature Ti is higher than the mean temperature Ta, a task having as low heating event frequency as possible is selected. Accordingly, in general, the heat quantity produced after processor Pi execution of the selected task becomes smaller than the average heat quantity.

Thus, the heat quantity produced in each processor becomes equalized, and as a result, the temperature of each processor becomes uniform, preventing a particular processor (or processor group) from becoming high temperature. As a result, necessity of attaching fans to each processor to a large extent or providing a large housing for heat design can be avoided, so that increase both in cost and size can be prevented. Further, it becomes possible to avoid restraint of processor voltage and frequency, and maximum capacity utilization of each processor can be attained.

In the above step S2, the comparison of Ti>Ta may be replaced by Ti≧Ta. Also, the comparison in step S3 may be replaced by E<Ea, replacing the comparison in step S6 by E≧Ea.

(3) A Third Task Scheduling Method

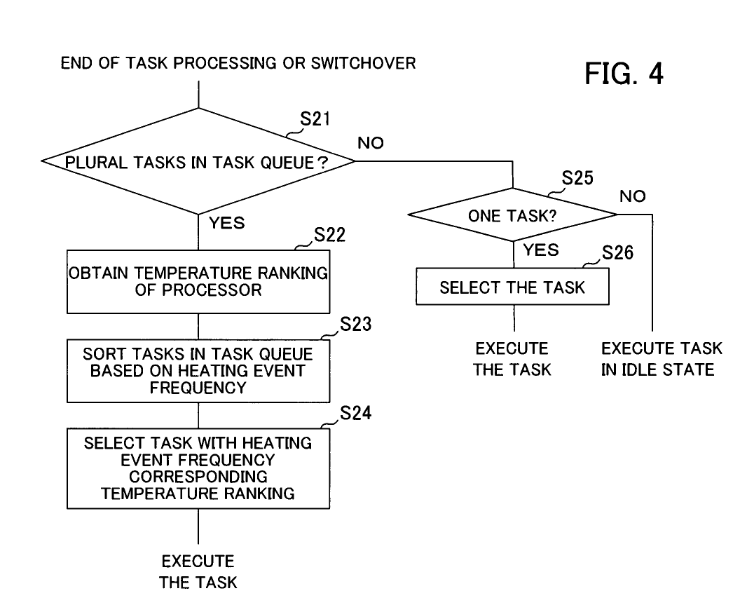

A third task scheduling method is to select and allocate a task based on the processor temperature and the heating event frequency in a similar way to the second task scheduling method. FIG. 4 shows a processing flow of the third task scheduling method to be executed in each processor. As described earlier, this processing is a part of the scheduler in the OS.

Processor Pi judges whether a plurality of tasks are existent in the task queue (S21). If a plurality of task are existent in the task queue (YES in S21), processor Pi obtains the ranking (defined as r) of the temperature Ti of the processor Pi concerned in the order arranged from the lowest temperature, based on the processor temperature data stored in shared memory 2 (S22).

Succeedingly, based on the heating event frequency, processor Pi sorts the tasks in the task queue in the order from the highest heating event frequency toward lower heating event frequency (S23).

Next, processor Pi selects a single task from the tasks having a heating event frequency corresponding to the rank r of the temperature Ti of the processor Pi concerned obtained in step S22 (S24), and executes the selected task.

Here, the heating event frequency corresponding to the rank r of the temperature Ti of the processor Pi concerned is exemplarily determined in the following way. First, processor Pi divides the tasks in the task queue into n groups, G1-Gn (where n is equal to the number of processors P1-Pn) in descending order from the highest heating event frequency. Thereafter, processor Pi selects one task from the tasks belonging to group Gr corresponding to the rank r of the temperature of the processor Pi concerned. Namely, when the temperature of the processor Pi concerned ranks the r-th from the lowest among the entire processors, a task belonging to the r-th group Gr from the highest of the heating event frequency is selected.

With this mechanism, a task having a relatively high heating event frequency is allocated to a processor having a relatively low temperature, and a task having a relatively low heating event frequency is allocated to a processor having a relatively high temperature. As a result, the heat quantity generated by each processor becomes balanced, and the temperature of each processor becomes uniform. Thus, it becomes possible to prevent a particular processor (or processor group) from becoming high temperature. As a result, necessity of attaching fans to each processor to a large extent or providing a large housing for heat design can be avoided, so that increase both in cost and size can be prevented. Further, it becomes also possible to avoid restraint of the processor voltage and the frequency, so that maximum capacity utilization of each processor can be attained.

Additionally, when the number of tasks in the task queue (let p be the number) is less than the number of processors n (namely p<n), instead of dividing the tasks existent in the task queue into n groups, dividing processors into G1-Gp groups according to the order of the temperature from the lowest temperature, a task Tr corresponding to the group Gr to which the temperature Ti of processor Pi belongs is selected.

With this also, the heat quantity generated by each processor becomes balanced, so that the temperature of each processor becomes uniform. Thus it becomes possible to prevent a particular processor (or processor group) from becoming high temperature, needless to say.

Meanwhile, in step S21, of a plurality of tasks are not existent in the task queue, processor Pi executes the processing of steps S25 and S26. Because these steps S25 and S26 are identical to the steps S9 and S10 in FIG. 3 illustrated earlier, the description is omitted here.

### Second Embodiment

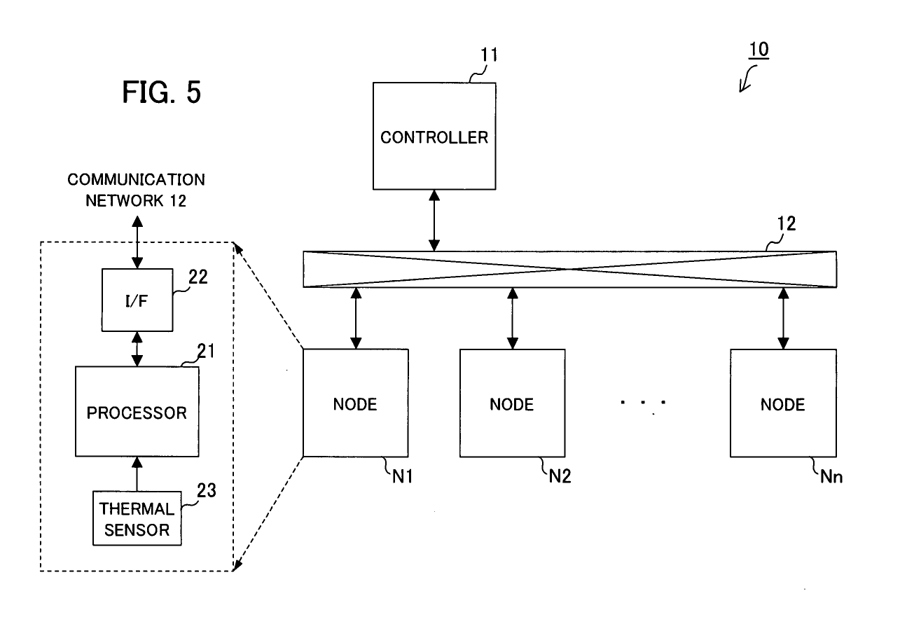

FIG. 5 shows a block diagram illustrating an exemplary configuration of a distributed processing system according to a second embodiment of the present invention. This distributed processing system 10 is a distributed computing system including a controller 11, n nodes N1-Nn, and a communication network 12.

Nodes N1-Nn and controller 11 are connected to communication network 12, and can communicate mutually via communication network 12. Communication network 12 is exemplarily constituted of LAN, Internet, etc.

Each node N1-Nn is, for example a computer, including a processor 21 constituted of CPU, MPU, etc., communication interface unit (I/F) 22 for performing communication interface processing, and a thermal sensor 23 for measuring temperature of processor 21.

Controller 11 is, for example a computer, of which internal memory (not shown) has data identical to the data in shared memory 2 shown in FIG. 2. Namely, the internal memory has the OS including the scheduler, application programs, temperature data of the processors, heating event frequency data, task queues, etc.

Further, it is also possible that controller 11 is provided with an internal timer, shifts a task in a predetermined sleep state to a wakeup state triggered by an interruption signal of the timer, allocates this task to any node, and enables the node concerned to execute the task.

According to the embodiment of the present invention, controller 11 dedicatedly performs task scheduling, and does not execute tasks. For this purpose, controller 11 executes the scheduler stored in the internal memory to perform task scheduling of nodes N1-Nn.

In the task scheduling processing, each node N1-Nn transmits a task allocation request to controller 11. In response to this request, controller 11 may select a task and allocate the task to the node having transmitted the request, or select a task and allocate the task to a node in the idle state. Whether a node is in the idle state may be detected by a state notification transmitted from each node N1-Nn to controller 11, or by periodically checking the states of nodes N1-Nn.

According to this embodiment, temperatures T1-Tn in the processor temperature data are the temperatures of the respective processors 21 in nodes N1-Nn. In the same way as the first embodiment described earlier, processor 21 in each node reads out, at certain intervals, the temperature of its own measured by thermal sensor 23, and transmits the readout temperature to controller 11 via I/F 22 and communication network 12. Controller 11 stores the temperatures transmitted from each node into the internal memory.

Further, the mean temperature Ta is calculated by controller 11 based on the temperatures T1-Tn. Each time at least one of the temperatures T1-Tn is transmitted to controller 11 and updated (stored), controller 11 obtains the mean temperature Ta based on the updated values.

Each heating event frequency E1-Em of each task program K1-Km is a value of the heating event frequency obtained from the number of executed instructions, the processing time (or the number of clocks), etc. that are measured by the performance monitoring function provided in each processor 21 in nodes N1-Nn. After a certain task is allocated by controller 11 and the task is executed, each processor 21 in the nodes transmits to controller 11 the number of executed instructions, the processing time, etc. that are measured by the performance monitoring function. Based on these values transmitted from each node, controller 11 calculates the heating event frequency in a similar way to that performed in the first embodiment, and stores (updates) the heating event frequency into the internal memory, using the method (a) or (b) described in the first embodiment.

Also, the mean heating event frequency Ea is calculated and stored by controller 11 in the same way as in the first embodiment.

In such distributed processing system 10, controller 11 performs task selection and allocation by executing the first, the second or the third task scheduling method in the aforementioned first embodiment. More specifically, the task scheduling processing is performed in the following way.

(1) A First Task Scheduling Method

When allocating a task in the sleep state to a node after shifting the task state into the wakeup state, for example caused by the interruption signal of the internal timer, controller 11 confirms whether anode(s) in the idle state exists. When there are a plurality of nodes in the idle state, controller 11 selects a processor having the lowest temperature among these nodes, and allocates the selected node a task to be shifted to the wakeup state and let the task be executed.

As such, the task is allocated to the node having the lowest temperature among the nodes in the idle state and executed. Accordingly, the processor heat quantity of each node proceeds to be equalized, and as a result, the temperature of each node can be made uniform.

Here, when there is a single node in the idle state, it may be possible to allocate a task to this node, or to allocate a task to another node having the lowest temperature. Also, when there is no node in the idle state, it may be possible to allocate a task to the node having the lowest temperature. If the task is allocated to the node that is not in the idle state, it is also possible to suspend the task in execution, and execute the task newly allocated when the task newly allocated has higher priority than the task in execution.

(2) A Second Task Scheduling Method

On receipt of a task allocation request from node Ni, controller 11 executes the processing shown in the flowchart of FIG. 3 based on the temperature Ti of node Ni, the mean temperature Ta, the mean heating event frequency Ea, and each heating event frequency E1-Em, and selects a task to be allocated to node Ni. Controller 11 then allocates the selected task to node Ni.

It is also possible that controller 11 detects node Ni in the idle state, selects a task using the processing of the flowchart shown in FIG. 3 for node Ni in the idle state, and allocates the selected task.

With this, the heat quantity produced from each node proceeds to be equalized, and as a result, each processor temperature becomes uniform. Thus, it becomes possible to prevent a processor (processor group) of a particular node from becoming high temperature.

(3) A Third Task Scheduling Method

On receipt of a task allocation request from node Ni, controller 11 executes processing of the flowchart shown in FIG. 4, and selects a task to be allocated to node Ni. Controller 11 then allocates the selected task to node Ni.

It is also possible that controller 11 detects node Ni in the idle state, selects a task using the processing of the flowchart shown in FIG. 3 for node Ni in the idle state, and allocates the selected task.

With this, the heat quantity produced from each node proceeds to be equalized, and as a result, each processor temperature becomes uniform. Thus, it becomes possible to prevent a processor (processor group) of a particular node from becoming high temperature.

### Other Embodiments

In place of processor temperature used in the first and the second embodiments, it is possible to use the consumption power of the processor, as either processor (node) selection criterion or task selection criterion. In this case, a consumption power measuring circuit either embedded into each processor or attached onto each processor measures the consumption power. In either shared memory 2 or the internal memory of controller 11, an accumulated value and an average value of the consumption power of each processor are stored in place of processor temperature.

In the first and the second embodiment, instead of obtaining the heating event frequency for the entire instructions to be executed, it is also possible to obtain the heating event frequency only for the floating-point arithmetic instructions that produce a large heat quantity (and power consumption).

In the second embodiment, a node may also be a multiprocessor system including a plurality of processors as shown in FIG. 1. In this case, controller 11 may select and allocate tasks for respective processors in each node.

Additionally, even in the multiprocessor system shown in the first embodiment, it is also possible to provide a controller separate from processors P1-Pn, so that this controller performs the function of controller 11 in the second embodiment, and performs the task scheduling for processors P1-Pn.

### INDUSTRIAL APPLICABILITY

The present invention is applicable to a distributed processing system such as a multiprocessor system, and a distributed computing system having a plurality of computers connected to a communication network.

According to the present invention, it is possible to make temperature of each processing unit (processor, computer, etc.) in a distributed processing system to be equalized. As a result, necessities of attaching a large-scale fan to each processing unit or designing a large housing for the heat design can be avoided, and increase in both cost and size of the system can be prevented. Further, it becomes also possible to avoid restraint in the voltage and the frequency of each processing unit, and maximum capacity utilization of each processing unit can be attained.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

1. A task scheduling apparatus scheduling a plurality of tasks to a plurality of processing units provided in a distributed processing system having said plurality of processing units which process distributed tasks, and having a plurality of measuring apparatuses for measuring temperature or consumption power of each of said processing units, said task scheduling apparatus comprising:
a comparator comparing temperatures or consumption powers of each of said processing units measured by said measuring apparatuses; and
a task allocator for allocating tasks to one processing unit having the lowest temperature or the lowest consumption power measured by said measuring apparatus after the comparison by said comparator.

2. The task scheduling apparatus according to claim 1,
wherein said task scheduling apparatus is provided in at least one of said plurality of processing units, and executes said task scheduling for said processing unit of interest or other processing units.

3. The task scheduling apparatus according to claim 1,
wherein said comparator compares temperatures or consumption powers of processing units in the idle state among said plurality of processing units.

4. A task scheduling apparatus scheduling a plurality of tasks to a plurality of processing units provided in a distributed processing system having said plurality of processing units which process distributed tasks, and having a plurality of measuring apparatuses for measuring temperature or consumption power of each of said processing units, said task scheduling apparatus comprising:
a memory storing characteristic values of tasks related to degree of temperature rise or consumption power increase of each processing unit caused by execution of each task on a task-by-task basis; and
a task allocator selecting a task to be allocated to an object processing unit from tasks waiting for execution, based on both temperature or consumption power measured by said measuring apparatus, and said task characteristic values stored in said memory with respect to said object processing unit, and allocating said selected task to the object processing unit.

5. The task scheduling apparatus according to claim 4,
wherein said characteristic value is an event frequency representing the number of processed instructions per unit time in each task, and
said task allocator selects a task having an event frequency not higher than, or lower than, mean event frequency value of tasks having been executed so far from tasks waiting for execution, and allocates the selected task to the object processing unit, when temperature of the object processing unit is not lower than, or higher than, the mean temperature of the plurality of processing units, or when consumption power of the object processing unit is not lower than, or higher than, the mean consumption power of the plurality of processing units.

6. The task scheduling apparatus according to claim 5,
wherein said task allocator allocates to the object processing unit a task having the lowest event frequency among tasks waiting for execution, when there is no task having an event frequency not higher than, or lower than, the mean event frequency value of the tasks having been executed so far, among tasks waiting for execution.

7. The task scheduling apparatus according to claim 4,
wherein said characteristic value is an event frequency representing the number of processed instructions per unit time in each task, and
said task allocator selects a task having an event frequency not lower than, or higher than, the mean event frequency value of tasks having been executed so far from tasks waiting for execution, and allocates the selected task to the object processing unit, when temperature of the object processing unit for task allocation is not higher than, or lower than, the mean temperature of said plurality of processing units, or when consumption power of the object processing unit is not higher than, or lower than, the mean consumption power of said plurality of processing units.

8. The task scheduling apparatus according to claim 7,
wherein said task allocator allocates to the object processing unit a task having the highest event frequency among tasks waiting for execution, when there is no task having an event frequency not lower than, or higher than, the mean event frequency value of the tasks having been executed so far, among tasks waiting for execution.

9. The task scheduling apparatus according to claim 4,
wherein said characteristic value is an event frequency representing the number of processed instructions per unit time in each task, and
said task allocator obtains a temperature ranking of the object processing unit among said plurality of processing units, sorts tasks waiting for execution based on said event frequency values, and selects and allocates a task having an event frequency ranking corresponding to said temperature ranking.

10. The task scheduling apparatus according to claim 9,
wherein said task allocator sorts tasks in order from the lowest event frequency to the highest event frequency when temperatures are ranked in order with the highest temperature first, while said task allocator sorts tasks in order from the highest event frequency to the lowest event frequency when the temperatures are ranked in order with the lowest temperature first.

11. The task scheduling apparatus according to claim 4,
wherein said characteristic value stored in the memory is the number of instructions included in each task, the number of instructions processed per unit time, the number of accesses to the memory performed at each task execution, the number of accesses to the memory per unit time, the total value of said number of instructions and said number of accesses, the total value of said number of instructions processed per unit time and said number of accesses to the memory per unit time, or the processing time required for processing each task.

12. The task scheduling apparatus according to either one of claim 5,
wherein said instruction is a floating-point arithmetic instruction.

13. The task scheduling apparatus according to either one of claim 4,
wherein said task scheduling apparatus is one of said plurality of processing units, which performs the task scheduling to said processing unit of interest or other processing units.

14. A distributed processing system having a plurality of processing units for processing a plurality of distributed tasks, comprising:
a measuring apparatus measuring temperature or consumption power of each of said plurality of processing units; and
a task scheduling apparatus provided separately from said plurality of processing units, or provided in at least one of said plurality of processing units, comparing temperature or consumption power of each processing unit measured by said measuring apparatus, and allocating a task to a processing unit having the lowest temperature or the lowest consumption power measured by said measuring apparatus after said comparison.

15. A distributed processing system having a plurality of processing units for processing a plurality of distributed tasks, comprising:
a measuring apparatus measuring temperature or consumption power of each of said plurality of the processing units;
a memory storing characteristic values of tasks related to degree of temperature rise or consumption power increase in each processing unit caused by execution of each task on task-by-task basis; and
a task allocator selecting a task to be allocated to an object processing unit for task allocation from among the tasks waiting for execution, based on both temperature or consumption power measured by said measuring apparatus and said task characteristic values stored in said memory with respect to said object processing unit for task, and allocating said selected task to said object processing unit.

16. In a distributed processing system having a plurality of processing units for processing a plurality of distributed tasks and a measuring apparatus for measuring temperature or consumption power of each processing unit, a task scheduling method executed either in at least one of said plurality of processing units or in a control unit provided separately from said plurality of processing units, said task scheduling method comprising:
comparing temperature or consumption power of each processing unit measured by said measuring apparatus; and
allocating a task to a processing unit having the lowest temperature or the lowest consumption power measured by said measuring apparatus after said comparison.

17. In a distributed processing system having a plurality of processing units for processing a plurality of distributed tasks and a measuring apparatus for measuring temperature or consumption power of each processing unit, a task scheduling method executed either in at least one of said plurality of processing units or in a control unit provided separately from said plurality of processing units, said task scheduling method comprising:
selecting a task to be allocated to an object processing unit for task allocation from among tasks waiting for execution, based on both temperature or consumption power measured by said measuring apparatus and task characteristic values stored in either an internal memory or an external shared memory, being related to degree of temperature rise or consumption power increase in each processing unit caused by execution of each task with respect to the object processing unit for task allocation; and
allocating said selected task to said object processing unit.

18. A program for enabling either at least one of a plurality of processing units for processing a plurality of distributed tasks, or a computer of a control unit provided separately from said plurality of processing units, to execute steps, said steps comprising:
comparing temperature or consumption power of each processing unit measured by a measuring apparatus for measuring temperature or consumption power of each processing unit; and
allocating a task to a processing unit having the lowest temperature or the lowest consumption power measured by said measuring apparatus after said comparison.

19. A program for enabling either at least one of a plurality of processing units for processing a plurality of distributed tasks, or a computer of a control unit provided separately from said plurality of processing units, to execute steps, said steps comprising:
selecting a task to be allocated to an object processing unit for task allocation from among tasks waiting for execution, based on both temperature or consumption power measured by a measuring apparatus and task characteristic values stored in either an internal memory or an external shared memory, being related to degree of temperature rise or consumption power increase in each processing unit caused by execution of each task with respect to said object processing unit for task allocation; and
allocating said selected task to said object processing unit.

20. The task scheduling apparatus according to claim 2,
wherein said comparator compares temperatures or consumption powers of processing units in the idle state among said plurality of processing units
